(19) United States
(12) Patent Application Publication
(10) Pub. No.: US 2012/0216578 A1
(43) Pub. Date: Aug. 30, 2012

(54) GLASS FURNACE HAVING CONTROLLED SECONDARY RECIRCULATION OF THE GLASS

(75) Inventors: François Pahmer, Ris-Orangis (FR); Bertrand Strock, Ris-Orangis (FR)

(73) Assignee: FIVES STEIN, Ris Orangis (FR)

(21) Appl. No.: 13/501,287

(22) PCT Filed: Oct. 6, 2010
(86) PCT No.: PCT/IB2010/054521

§ 371 Date: May 10, 2012

(30) Foreign Application Priority Data
Oct. 14, 2009 (FR) 09/04925

(51) Int. Cl. C03B 5/16

(52) U.S. Cl. 65/347

(57) ABSTRACT

The invention relates to a furnace for melting and fining glass, which includes: a vault provided with a heating means, a hearth (2) forming the bottom of a vat containing a bath (3) of molten glass, a width restriction (4), in particular a corset, defining a downstream portion (5) and an upstream portion (6) in the vat, and an outlet through which the molten glass is discharged, a secondary recirculation loop (B) for the molten glass forming in the bath between a hotter inner area of the furnace and the cooler outlet, said loop passing through the corset; the furnace comprises a means (M) for adjusting the width through which the glass can pass into the secondary recirculation loop, said adjustment means being submerged in the bath and extending vertically over most of the depth of the bath.

The invention relates to improving the control of glass flow in a glass furnace, the furnace comprising:
a crown equipped with heating means;
a hearth forming the bottom of a tank containing a bath of molten glass;
a width restriction, especially a waist, defining a downstream part and an upstream part in the tank;
a secondary loop of recirculating molten glass, formed in the bath between a hotter internal zone of the furnace and the downstream part of the tank at a lower temperature, this loop passing through the width restriction; and
an outlet through which the molten glass is removed.

The secondary recirculating loop flows counter to the primary recirculating loop located beside where the batch materials are charged into the furnace.

The invention more particularly, but not exclusively, relates to a furnace for clear or extra-clear glass.

The secondary recirculating loop, also called the secondary roll, creates problems for industrial producers of flat glass. The recirculation of glass in this roll, especially in float glass furnaces, promotes corrosion of the refractories of the inner wall of the furnace, in particular the angular blocks of the waist, thereby reducing the quality of the glass. In addition, the power consumption of the furnace increases with the flow rate of the roll.

The aim of the waist, a sort of tank having a reduced width relative to the upstream (furnace) and downstream (working end) parts of the tank, is especially to reduce the effect of the roll, but the refractory angular blocks located at the inlet of the waist are subject to intense corrosion, reducing the quality of the glass.

Furthermore, during the production of clear or extra-clear glass, the flow rate of the recirculated glass is greatly increased. In addition, the glass is hotter on average. The corrosion is then more rapid because the corrosion rate increases with the speed and temperature of the glass.

The aim of the invention is, above all, to improve the control of the flow of the glass in the secondary recirculating loop or roll in order to reduce corrosion of the refractories, in particular of the angular blocks, and/or to reduce the power consumption of the furnace while ensuring the quality of the glass.

According to the invention, a furnace of the type defined above, is characterized in that it comprises a means for adjusting the flow width of the glass in the secondary recirculating loop, this adjusting means being immersed in the bath and extending vertically through part of the depth of the bath.

A transverse dam, perpendicular to the flow of the glass, is commonly placed in the waist. Its main function is to retain impurities that are located on the surface of the bath but that also influence the flow of the glass, especially by slowing the recirculation outflow of the secondary recirculation loop. The dam is positioned vertically so as to be partially immersed in the bath to a small depth. The adjusting means according to the invention is positioned upstream of the dam in the direction of the flow of the output.

According to a first exemplary application, the immersed part of the adjusting means extends, from the surface, to a depth in the bath corresponding to the output and at least part of the recirculation outflow, without reaching the recirculation inflow, so as to limit the corrosion of the angular blocks and to slow down the recirculation outflow. Advantageously, the distance between the lower edge of the adjusting means and the hearth is larger than the distance between the hearth and the line separating the recirculation outflow and the recirculation inflow. According to one embodiment, the immersed part extends to about one third of the depth of the bath, from the surface. This configuration is especially advantageous when using a furnace with no dam. When a dam is present in the waist, this configuration also allows corrosion of the dam refractory to be limited.

According to another exemplary application, the immersed part of the adjusting means extends to a greater depth in the bath corresponding to the output, the recirculation outflow and at least part of the recirculation inflow. Advantageously, the distance between the lower edge of the adjusting means and the hearth is smaller than the distance between the hearth and the line separating the recirculation outflow and the recirculation inflow. According to one embodiment, the immersed part extends to at least two thirds of the depth of the bath, from the surface. This configuration allows corrosion of the angular blocks to be limited and the outflow and inflow of the recirculation loop to be slowed down.

According to another exemplary application of the invention, the immersed part of the adjusting means consists, from the surface, of a connecting element that has no significant effect on the flow of the glass, and, lower down, a flat element that influences the flow of the glass. This configuration is advantageously used to slow down the inflow of the recirculation loop without influencing the output and the outflow. In this case, the flat element of the adjusting means only extends through the recirculation inflow, through at least part of the recirculation inflow.

The means for adjusting the flow width of the glass is generally located in the zone upstream of the width restriction, in particular at the upstream inlet of the width restriction or waist.

The means for adjusting the flow width of the glass may comprise at least one vertical, cooled, in particular water-cooled, flat, hollow element that is permanently immersed in the bath of molten glass. Advantageously, the flat element is made of metal. It may comprise tubes in which a coolant is made to flow.

It is possible to cool only a fraction of the height of the means for adjusting the flow width of the glass, only the upper part making contact with the output and recirculation outflow or the deepest part making contact with the recirculation inflow of the secondary recirculating loop.

According to another possibility, the means for adjusting the flow width of the glass comprises at least one vertical plate made of a refractory material.

Advantageously, the means for adjusting the flow width of the glass is vertically adjustable; it is held by a device that can move the means vertically.

The means for adjusting the flow width of the glass may be laterally adjustable, in particular by rotation about a vertical axis.

In the case where the adjusting means consists of a flat vertical element, this flat element may be mounted so as to be able to rotate about a vertical geometric axis located near the upstream end of the flat element.

Preferably, at least one means for adjusting the flow width of the glass is placed on each side of the furnace, the adjusting means being symmetric about a longitudinal vertical plane running through the middle of the furnace.

Thus, according to the invention, a transverse restriction of the flow width of the secondary roll is created. This has the advantage of allowing the width of the flow of the glass in the width restriction to be controlled. This transverse restriction may be produced using various parts, the parts preferably being made of metal, and all or some of the part being water-cooled, or made of a refractory material.

The invention consists, in addition schematic to the arrangements presented above, of a number of other arrangements which will be looked at more closely below with respect to a nonlimiting embodiment described with reference to the appended drawings. Regarding the drawings:

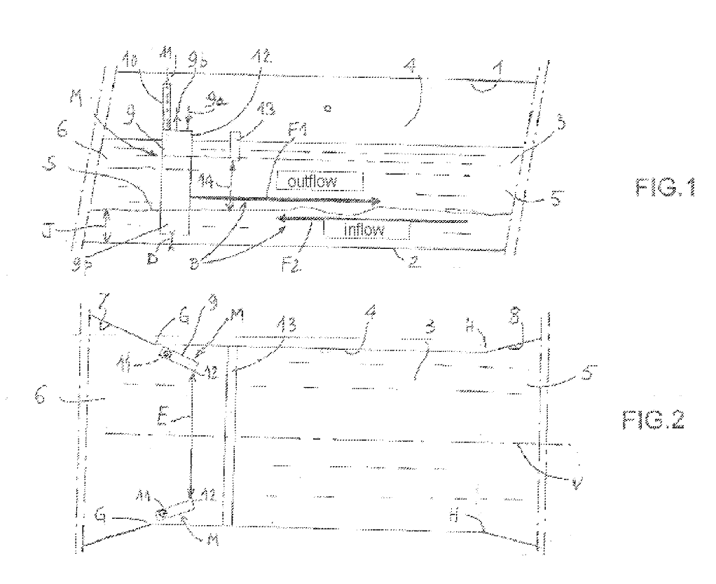

FIG. 1 is a partial vertical schematic cross section lengthwise through the waist of a flat-glass furnace according to the invention; and

FIG. 2 is a schematic top view, relative to FIG. 1, of the waist and the bath of molten glass.

In FIGS. 1 and 2 of the attached drawings, part of a flat-glass furnace comprising a crown 1 and a hearth 2, the hearth forming the bottom of a tank containing a bath 3 of molten glass, may be seen.

The furnace comprises a waist 4 of smaller width, defining a downstream part 5 (on the right in FIG. 1) and an upstream part 6 (on the left in FIG. 1) in the tank. The direction to consider when defining upstream and downstream is that which leads from the internal zone of the furnace, located on the left in FIG. 1, toward the outlet located on the right. The sidewalls of the furnace converge in the zone 7 (FIG. 2) near the inlet of the waist and diverge in the zone 8 (FIG. 2) turned toward the outlet (not shown) of the furnace, through which outlet the molten glass is removed.

A secondary loop B of recirculating molten glass forms between the hotter, internal zone of the furnace, located on the left in FIGS. 1 and 2, and the outlet that is at a lower temperature. The liquid glass circulates clockwise in this loop in the example shown in FIG. 1. The upper layers of the bath, composed of the output of the furnace and recirculating glass, move toward the outlet, i.e. toward the right, in a convective outflow F1 indicated by an arrow, whereas the lower layers, composed of recirculating glass and neighboring the hearth 2, move toward the internal zone, i.e. toward the left, in a convective inflow F2, indicated by an arrow. An (imaginary) separating line S is located between the inflow and outflow. The loop B passes through the waist 4.

The convective outflow and inflow causes corrosion of the refractory internal wall of the furnace, in particular of the angular blocks G, H at the inlet and outlet of the waist 4. The rate of corrosion increases when the flow rate of the convective flows of glass in the loop B increases, and inversely decreases when this flow rate decreases.

According to the invention, the flow rates of the outflow F1 and inflow F2 of the recirculation loop B are made to decrease by creating a transverse restriction E (FIG. 2), preferably in the inlet zone of the waist 4. This transverse restriction allows the flow width of the glass to be controlled in the waist 4 and thus allows the furnace to be adapted to various glass colors or production rates, it being impossible, by definition, to adjust the waist 4 since its dimensions are set when the furnace is designed and it is made of refractories.

The transverse restriction E is produced using a means M for adjusting the flow width of the glass, in the secondary recirculation loop B, in part of the height of the bath (FIG. 1). The immersed part of the adjusting means extends differently through the depth of the bath depending on whether it is desired to affect only the output and the recirculation outflow, only the recirculation inflow, or the output and the outflow and the inflow.

According to one embodiment, the distance D (FIG. 1) between the lower edge of the adjusting means M and the hearth 2 is larger than the distance J between the hearth and the line S separating the recirculation outflow F1 and the recirculation inflow F2. Thus, the adjusting means M is immersed only in the output and the recirculation outflow F1.

In general, an adjusting means M is placed on each side of the furnace (FIG. 2), the adjusting means M being symmetric about a longitudinal vertical plane V running through the middle of the furnace.

Each adjusting means M advantageously comprises at least one flat, hollow vertical element 9, shown schematically in FIGS. 1 and 2 by a rectangular outline, the element being cooled by water that enters via an inlet channel 9a and leaves via an outlet channel 9b so as to remove its heat to the exterior. The flat element 9 is permanently immersed in the bath of molten glass. This flat element 9 is hollow and preferably made of metal. It may be produced with a series of tubes having parallel vertical axes located in the same plane, through which tubes cooling water is made to flow. The flat element 9 may be cooled over its entire height or over only part of this height.

According to a variant, the means M for adjusting the flow width of the glass may be produced in the form of a vertical plate made of refractory material.

The constituent parts of the adjusting means M are introduced symmetrically into the waist, either via the sidewalls or via the crown. Each adjusting means M is held by a mechanical system 10 provided to allow the means M to be moved vertically, in order to adjust this means M relative to the line S separating the outflow and inflow.

In addition, it is important to be able to adjust the lateral position of the means M relative to the tank. Advantageously, when the means M consist of a flat vertical element 9, i.e. a plate, this flat element is mounted so as to be able to rotate about a vertical geometric axis 11 located near the upstream end of the flat element 9. The rotation of the flat element 9 about this axis 11 makes an angle to the flow of the glass and ensures that the width E between the downstream ends 12 of the flat elements 9 is reduced. Thus the reduction in the width of the flow cross section of the glass is ensured for the output and the recirculation outflow, the output, the recirculation outflow and the recirculation inflow, or only the recirculation inflow, depending on the configuration employed.

As a variant embodiment, the flat element 9 is mounted so as to be able to rotate about a vertical geometric axis 11 located near the downstream end of the flat element 9; the device comprising a means for adjusting the lateral position of the vertical geometric axis 11.

The means M for adjusting the width are preferably placed at the inlet of the waist 4 in order to reduce the flow rate of the glass beside the refractory walls and/or to also reduce the temperature of the glass beside said refractories, thus reducing their corrosion.

The installation of such cooled, preferably water-cooled, parts is not incompatible with the general operation of the melting furnace. This is because the waist 4 is also used to cool the glass, between the upstream melting/refining zone and the downstream working end, substantially and rapidly.

In addition, a transverse dam 13 may be provided perpendicular to the flow of the glass, the dam consisting of a water-cooled metal cooling device installed vertically so as to be immersed to a small depth in the bath of molten glass 3. The vertical dam 13 extends across the entire width of the waist 4.

Upstream of a dam, the glass is stratified heightwise through the bath. The composition of the glass varies depending on the strata with, for example, a lower concentration of NaO at the surface because of evaporation. The presence of the dam forcibly submerges the glass into the bath, disrupting the stratification. The solution of the invention advantageously replaces a dam in its function of reducing the outflow of the recirculation loop because the solution of the invention allows the secondary recirculation of the glass to be reduced by reducing the flow cross section in the waist while preserving sufficient stratification of the glass outflow.

The solution of the invention also allows the rate of corrosion of the walls and the power consumption of the furnace to be reduced. It is particularly advantageous for the production of clear or extra-clear glass.

1. A furnace for melting and refining glass, comprising:
a crown equipped with heating means;
a hearth (2) forming the bottom of a tank containing a bath (3) of molten glass;
a width restriction (4), especially a waist, defining a downstream part and an upstream part in the tank;
a secondary loop (B) of recirculating molten glass, formed in the bath between a hotter internal zone of the furnace and the downstream part of the tank at a lower temperature, this loop passing through the width restriction; and
an outlet through which the molten glass is removed,
characterized in that it comprises a means (M) for adjusting the flow width of the glass in the secondary recirculating loop, this adjusting means being immersed in the bath and extending vertically through part of the depth of the bath.

2. The furnace as claimed in claim 1, characterized in that the immersed part of the adjusting means (M) extends, from the surface, to a depth in the bath (3) corresponding to the output and at least part of the recirculation outflow.

3. The furnace as claimed in claim 2, characterized in that the distance (D) between the lower edge of the adjusting means (M) and the hearth (2) is larger than the distance (J) between the hearth and the line (S) separating the recirculation outflow (F1) and the recirculation inflow (F2).

4. The furnace as claimed in claim 1, characterized in that the immersed part of the adjusting means (M) extends, from the surface, to a depth in the bath (3) corresponding to the output, the recirculation outflow and at least part of the inflow.

5. The furnace as claimed in claim 4, characterized in that the distance (D) between the lower edge of the adjusting means (M) and the hearth (2) is smaller than the distance (J) between the hearth and the line (S) separating the recirculation outflow (F1) and the recirculation inflow (F2).

6. The furnace as claimed in claim 5, characterized in that the deepest part (9p) of the adjusting means (M) makes contact with the recirculation inflow (F2) of the loop.

7. The furnace as claimed in claim 1, characterized in that the flat element (9) of the adjusting means (M) only extends through the recirculation inflow.

8. The furnace as claimed in any one of the preceding claims, characterized in that the means (M) for adjusting the flow width of the glass is located in the zone upstream of the width restriction (4).

9. The furnace as claimed in claim 8, characterized in that the means (M) for adjusting the flow width of the glass is located at the upstream inlet of the width restriction (4).

10. The furnace as claimed in any one of the preceding claims, characterized in that the means (M) for adjusting the flow width of the glass comprises at least one vertical, cooled, in particular water-cooled, flat, hollow element (9) that is permanently immersed in the bath of molten glass.

11. The furnace as claimed in claim 10, characterized in that the flat hollow element (9) is made of metal.

12. The furnace as claimed in either of claims 10 and 11, characterized in that only a fraction of the height of the means (M) for adjusting the flow width of the glass is cooled, only the upper part making contact with the output and recirculation outflow or the deepest part making contact with the recirculation inflow of the secondary recirculating loop.

13. The furnace as claimed in any one of claims 1 to 9, characterized in that the means (M) for adjusting the flow width of the glass comprises at least one vertical plate made of a refractory material.

14. The furnace as claimed in any one of the preceding claims, characterized in that the means (M) for adjusting the flow width of the glass is vertically adjustable.

15. The furnace as claimed in any one of the preceding claims, characterized in that the means (M) for adjusting the flow width of the glass is laterally adjustable.

16. The furnace as claimed in claim 15, characterized in that the means (M) for adjusting the flow width of the glass is laterally adjustable by rotation about a vertical axis (11).

17. The furnace as claimed in claim 16, in which the adjusting means (M) consists of a flat vertical element (9), characterized in that this flat element (9) is mounted so as to be able to rotate about a vertical geometric axis (11) located near the upstream end of the flat element (9).

18. The furnace as claimed in any one of the preceding claims, characterized in that at least one means (M) for adjusting the flow width of the glass is placed on each side of the furnace, the adjusting means (M) being symmetric about a longitudinal vertical plane (V) running through the middle of the furnace.
